(19) United States
(12) Patent Application Publication
(10) Pub. No.: US 2006/0157567 A1
(43) Pub. Date: Jul. 20, 2006

(54) Terminal with a touch panel display and touch panel display

(75) Inventors: Werner Baumann, Hasle b. B. (CH); Hugo Heinrich, Liebefeld (CH)

Correspondence Address: OLIFF & BERRIDGE, PLC, P.O. BOX 19928, ALEXANDRIA, VA, 22320, US

(73) Assignee: ACS Solutions Schweiz AG, Bern (CH)

(21) Appl. No.: 10/563,740

(22) PCT Filed: Jul. 30, 2003
(86) PCT No.: PCT/CH03/00524

§ 371 Date: Jan. 20, 2006

(51) Int. Cl. G06K 7/08; G07F 19/00

(52) U.S. Cl. 235/451; 235/379

(57) ABSTRACT

The inventive terminal (200), that may be realised in various embodiments, e.g. as access control terminal, pay telephone, point of sales terminal, ticket vending machine or automatic teller machine, comprises a touch panel display (100) and means for contactless communication with an IC-card (10) that is used to perform transactions requested by the holder of the IC-card (10). In order to allow communication between the IC-card (10) and the terminal (200), at least one antenna (112), designed to receive signals from and/or to send signals to the IC-card (10), is embedded in the touch panel display (100) so that the card reading and writing functionality is implemented in the touch panel display (100).

The present invention relates generally to a terminal with a touch panel display and to a touch panel display, i.e. a flat panel display enhanced with touch screen functionality.

The present invention further relates to publicly used terminals, in particular pay telephones, POS-(point of sales) terminals, such as ticket vending machines or automatic teller machines, or privately used terminals such as access control terminals, said terminals allowing contactless communication with an IC-card, such as a dual interface card, of a terminal user.

### BACKGROUND OF THE INVENTION

[1], U.S. Pat. No. 5,705,798, describes a commercial transaction system, used for conducting financial transactions, that utilizes terminals, e.g. automatic teller machines (ATM) that run predefined programs stored in the terminal in order to perform a transaction or transactions when an IC-card is placed in the terminal. When a terminal user uses an automatic teller machine, the automatic teller machine accepts the customer's IC-card when placed in a designated receptacle of a card reader and executes a stored resident program, which interacts with the terminal user and performs selected functions.

In [1], FIG. 1 the external portion of a financial transaction terminal is shown, which comprises in particular a touch-sensitive screen, i.e. a touch panel display, a card receptacle and a money receptacle. The touch screen presents the user with a hard, flat, non-tactile surface, projecting an imitation of a button or keyboard. The structure of a touch panel display, that comprises circuit layers arranged between a graphic layer and a glue layer, is shown in FIG. 8 (further information is available from http://www.touchpanels.co.uk/products.htm). Due to the rigidness of its graphic layer, normally a stable glass plate, the touch panel display is tamperproof. Since a damage of the graphic layer, caused by mistreatment of the device, will easily be noticed, the touch panel display is also tamperevident.

Transactions may be performed on this terminal as described below. When an IC-card is inserted into the card receptacle by the user, the touch-sensitive screen is activated to display a menu of functions which can be selected by the customer. The customer then activates one of selection buttons to choose a desired function. The customer can make further data entries as needed by pressing a number. Cash can be deposited or withdrawn from a customer's account by placing or receiving money in the money receptacle.

A terminal used as ticket vending machine is shown below in FIG. 1. The ticket vending machine 20 is equipped with a man-machine interface that comprises a display unit 1 enhanced with touch screen functionality. The display unit 1 is for example a touch sensitive LCD flat panel display as described in [2], U.S. Pat. No. 5,777,596, which allows a user to provide input into a computer device by simply touching an LCD display screen with a finger or a ball point pen. The ticket vending machine 20 further comprises an audio module 2 with a loudspeaker, a printer unit 3 designed to print travel tickets, a money receptacle 4 and a card reader 5 that is used to read user specific data from an inserted IC-card.

FIG. 2 shows a dual interface IC card 10 that operates for example in a manner compliant with the International Standards Organization (ISO) 7816 and 14443 standards. For this purpose the IC card 10 comprises an Integrated Circuit 11 that is designed to communicate with the card reader 5 over contacts according to the ISO 7816 transmission protocol or contactless according to the ISO 14443 transmission protocol as described in [3], International Publication WO 02/073522 A1. For contactless communication with the card reader 5 an inductive loop aerial or antenna 12 is embedded in the IC card 10 allowing communication without physically making contact. Coil arrangements serving as antennas for IC cards and readers can be realised in various ways. A coil arrangement for inductive contactless card- and identification systems is described for example in [4], EP 1 109 123 A1 and [5], U.S. Pat. No. 6,142,381.

Providing a card reader in the described terminals however significantly contributes to the overall cost of such a system. Further, operating a card reader is often time consuming and not very comfortable. Still, further, a major part of the maintenance calls for said terminals are caused by malfunctions of the card readers caused by mistreatment and tampering. Card readers are also not tamperevident, since the cause of a malfunction can often only be localised by an engineer.

In view of the above drawbacks in the prior art, it would be desirable to provide an improved terminal that comprises a touch panel display and that allows contactless communication with an IC-card. It would be desirable in particular to provide a terminal with a touch panel display that can be produced and maintained with reduced costs.

### SUMMARY OF THE INVENTION

The above and other objects of the present invention are achieved by a terminal with a touch panel display and a touch panel display according to claim 1 and claim 8.

The inventive terminal, that may be realised in various embodiments, e.g. as access control terminal, pay telephone, point of sales terminal, ticket vending machine or automatic teller machine, comprises a touch panel display and means for contactless communication with an IC-card that is used to perform transactions requested by the holder of the IC-card. In order to allow communication between the IC-card and the terminal, at least one antenna, designed to receive signals from and/or to send signals to the IC-card, is embedded in the touch panel display so that the card reading and writing functionality is implemented in the touch panel display.

The inventive terminal does therefore not require a separate card reader device which causes costs, maintenance and requires space within the terminal. Enhancement of touch panel displays from a man-machine-interface to an IC-card interface can be performed with a minimum of costs by integration of the antenna and preferably the complete communication circuitry, that allows data transfer between the terminal's main processor and the IC-card, in the touch screen module. The inventive touch panel display can therefore transmit the complete data traffic originating from the user side, data entered by the user and data read from the IC-card, over a common data bus and/or a card processor to the main processor. The communication protocol used to exchange data with the IC-card may therefore advantageously be implemented within the touch panel display module, so that protocol data units containing user data may be transferred over the common data bus according to a different, standardised or proprietary, format.

In a preferred embodiment the inventive touch panel display comprises therefore the complete circuitry required to implement the applied communication protocol, e.g. a protocol compliant to the ISO 14443 standard. With the integration of the circuitry used for the communication with the IC-card and the touch screen circuitry in a common circuit, production costs can further be reduced. Preferably the complete circuitry is realised as a flexible printed circuit that is contained for example as a layer integrated in the touch panel display.

The inventive touch panel display preferably comprises a receptacle designed to receive and hold the IC-card. The receptacle may be designed as a recess in the surface of the touch panel display or as a cavity within the touch panel display module that is accessible through an opening slot in the surface of the touch panel display. If a cavity is used, then the usable area of the touch panel display is practically not reduced.

In a further embodiment the touch panel display comprises at least one optical sensor that detects receipt of an IC-card in the receptacle allowing the control unit to perform the required activities. The optical sensors may also be used to read data written, e.g. as a bar code, on the surface of the IC-card.

As described above non-tactile touch panel displays, that are equipped with a solid graphic layer, are tamperproof, tamperevident and secure. These properties extended of course also to the card reader portion of the inventive touch panel displays, so that maintenance expenditures for the terminal can be reduced.

### BRIEF DESCRIPTION OF THE DRAWINGS

Some of the objects and advantages of the present invention have been stated, others will appear when the following description is considered together with the accompanying drawings, in which:

FIG. 1 shows the three-dimensional view of a known terminal 20, designed as a ticket vending machine, that comprises a touch panel display 1 and a card reader 5;

FIG. 2 shows an IC-card 10 with an antenna 12 that allows contactless communication with the card reader 5 of the terminal 20;

FIG. 3 shows a schematic illustration of an inventive terminal 200 with a touch panel display 100 that is designed to communicate with the IC-card 10 shown in FIG. 2;

FIG. 4 shows the placement of the IC-card 10 onto the touch panel display 100;

FIG. 5 shows a cross section of the touch panel display 100 that comprises an embedded coil 112 and a recess 101 for the placement of the IC-card 10;

FIG. 6 shows a touch panel display 100 with a slot 120 through which the IC-card can be inserted into a cavity 102;

FIG. 7 shows the three-dimensional view of a terminal 200 comprising an in inventive touch panel display 100;

FIG. 8 shows the structure of a known non-tactile touch panel display 100; and

FIG. 9 shows the structure of an inventive non-tactile touch panel display 100; and

FIG. 10 shows the touch panel display 100 of FIG. 9 with an IC-card 10 placed in the receptacle 101.

### DETAILED DESCRIPTION OF THE PREFERRED EMBODIMENTS

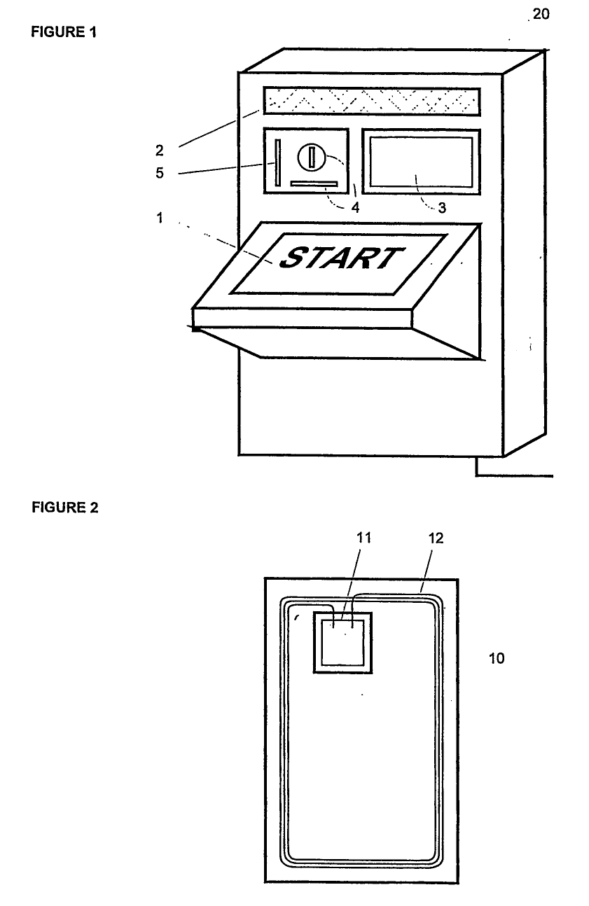

FIG. 1 shows a known terminal 20 that is used as a ticket vending machine. The terminal 20 comprises a touch panel display 1 used as a man-machine-interface and a card reader 5 with a receptacle for inserting an IC-card 10, a single or dual interface card, as shown in FIG. 2.

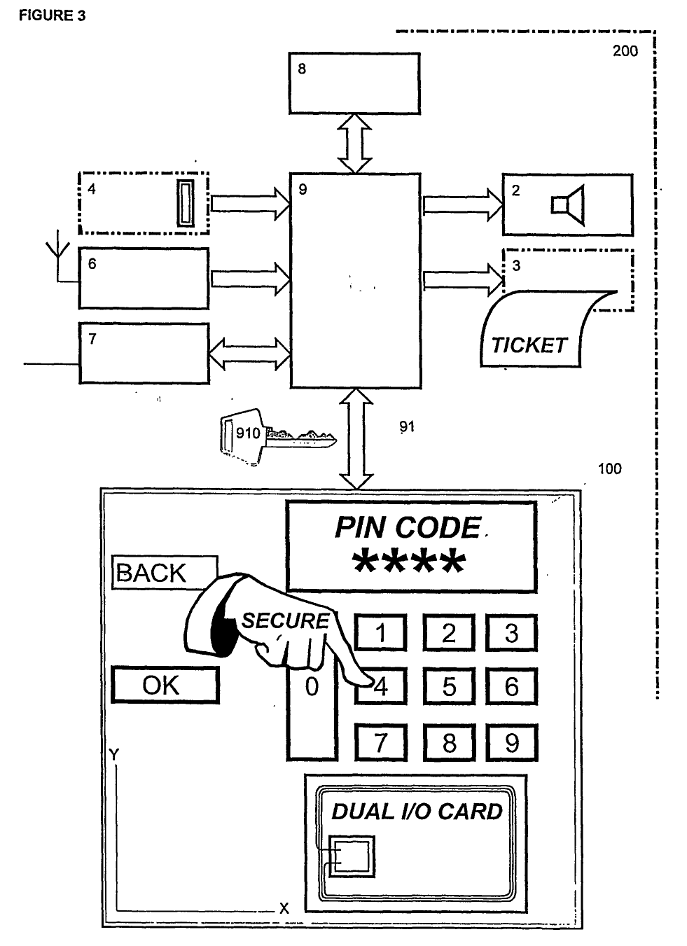

FIG. 3 shows a schematic illustration of a preferred embodiment of an inventive terminal 200 that is equipped with a main processor 9, which is connected to a memory module 8, an audio module 2, a ticket printer 3, a money receptacle 4, wireless and wired communication modules 6, 7 and over a databus 91 to an inventive touch screen display 100 that is used as man-machine interface.

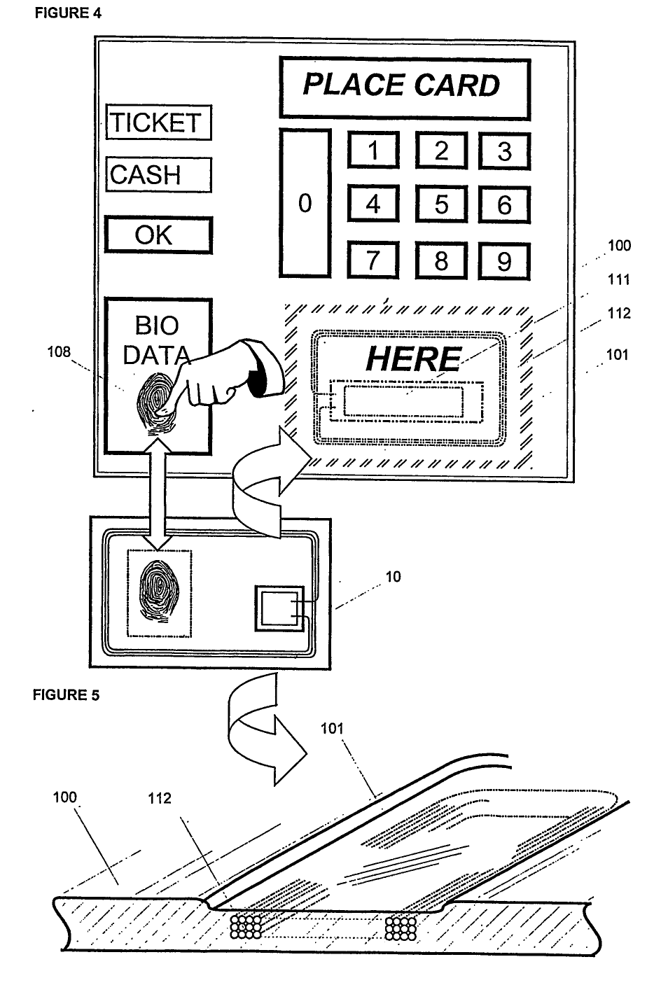

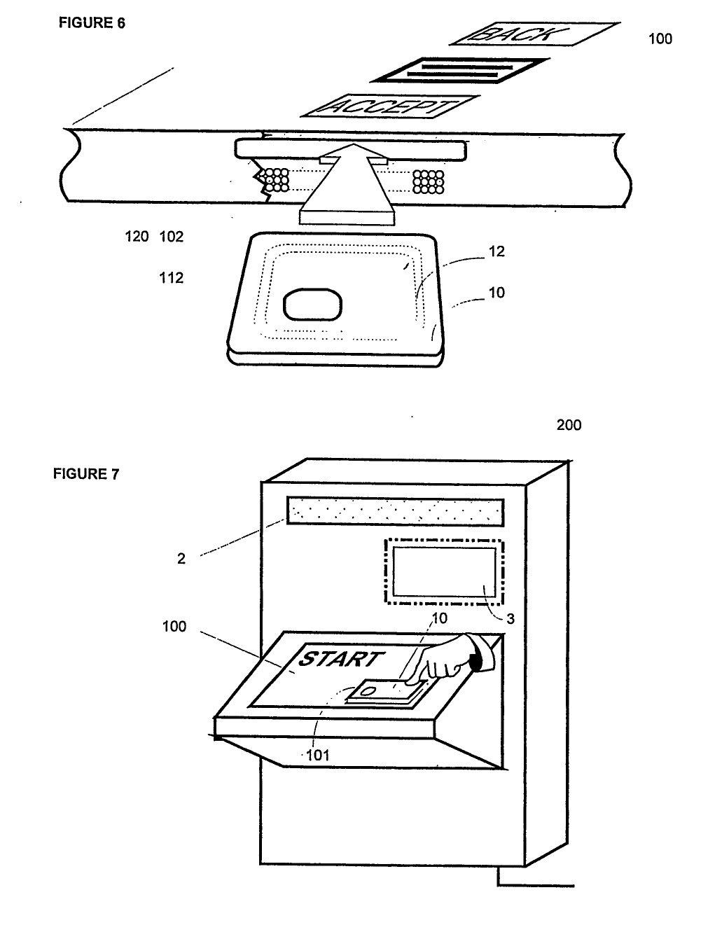

Embedded in the touch screen display 100 is an antenna 112 (see FIG. 4) that will be inductively coupled with the antenna 12 of an IC-card 10, when such an IC-card 10 is placed on the touch screen display 100. The antennas 12, 112 embedded in the IC-card 10 and the touch panel display 100 may comprise one or more coils that are used for transmitting and/or receiving data as defined by the applied transmission protocol. The coils may be arranged in the touch panel display 100 in the same manner as the arrangement of the coils on the IC-card 10. However, since the antenna 12 of the IC-card 10, after placement on the touch panel display 100, is in close vicinity to its antenna 112 various coil arrangements can be realised, that provide sufficient coupling. The touch screen display 100 may comprise one top layer, e.g. a glass plate, and at least one lower layer onto which the coils of the antenna 112 can be placed or printed. However, as shown in FIGS. 5 and 6 the antenna 112 can also be integrated into the top layer.

The circuitry 111 required implementing the applied communication protocol, e.g. a protocol compliant to the ISO 14443 standard as described in [3] or ISO 15693 as described in [7], International Publication WO 03/036561 A1, is preferably realised on a flexible printed circuit. Flexible printed circuits, which are described in [6], U.S. Pat. No. 6,211,936 B1 can be produced as a thin layer which can be integrated into the touch panel display 100. In order to reduce production costs, the circuitry used for the communication with the IC-card and the touch screen circuitry are integrated in a common circuit. In this event the complete data traffic originating from the user side, data entered by the user and data read from the IC-card, can be forwarded to the main processor 9 over a common data bus 91. The communication protocol used to exchange data with the IC-card 10 may therefore advantageously be implemented within the touch panel display module 100, so that protocol data units containing user data may be transferred over the common data bus 91 according to a different, standardised or proprietary format.

For security reasons the terminal user may be requested to provide identification data such as a personal identification code and/or biometric data such as a fingerprint, before transactions are performed. Biometric data may then be processed as described in [8], EP 1 263 164 A1. Biometric data may be read by means of a fingerprint detector 108 (see FIG. 4).

Methods and devices for secure handling of user data and smart cards are described for example in [9], International Publication WO 00/10134 and [10], International Publication WO 01/05085.

[9], WO 00/10134 relates to a security system for identity and authorisation checking for smart cards containing personal data comprising a smart card reader that validates personal data read from the smart card by means of data provided by a fingerprint detector.

[10], WO 01/05085 relates to a method for making secure data access and transfers in a computer system by storing session keys in the smart card and the host that are used for encrypting and decrypting data transferred between the host and the smart card. [10], WO 01/05085 further discloses the use of biometric data read by a fingerprint detector.

Methods for secure personal identification number entry are further described in [11], US 2003/0046590 A1.

In the inventive touch panel display, chip-sets produced by SCM Microsystems Inc., Fremont, Calif. 94539, may be used, which provide smart card interface capabilities for embedded environments. The inventive touch panel display 100 may be enhanced with Fingerprint & Smart Card Reader functionalities for example by means of the SCM Microsystem's STC II microcontroller.

FIG. 4 shows the placement of the IC-card 10 onto the touch panel display 100, which comprises a receptacle designed to receive and hold the IC-card 10. The touch panel display 100 further comprises a reader device for biometric data provided by the terminal user. The reader device may read for example data of a fingerprint. In order to authenticate the terminal user the biometric collected by the reader device may be compared with data stored in the IC-card 10.

In FIG. 3, key 910 symbolises that PIN code entry and data transfer in particular across databus 91 are secured.

The position for the placement of the IC-card 10 may be indicated to the terminal user by optical information provided on the touch panel display 100. In addition the touch panel display 100 may comprise a receptacle designed to receive and hold the IC-card 10.

The receptacle may be designed, as shown in FIG. 5, as a recess 101 in the surface of the touch panel display 100 or, as shown in FIG. 6 as a cavity 102 within the touch panel display module 100 that is accessible through an opening slot in the surface or a sidewall of the touch panel display 100.

FIG. 7 shows an inventive terminal 200 with an IC-card 10 placed in the receptacle of the touch panel display 100. The ticket printer 3 is shown with dashed lines, indicating that the ticket information or a corresponding code can also be written into the IC-card 10.

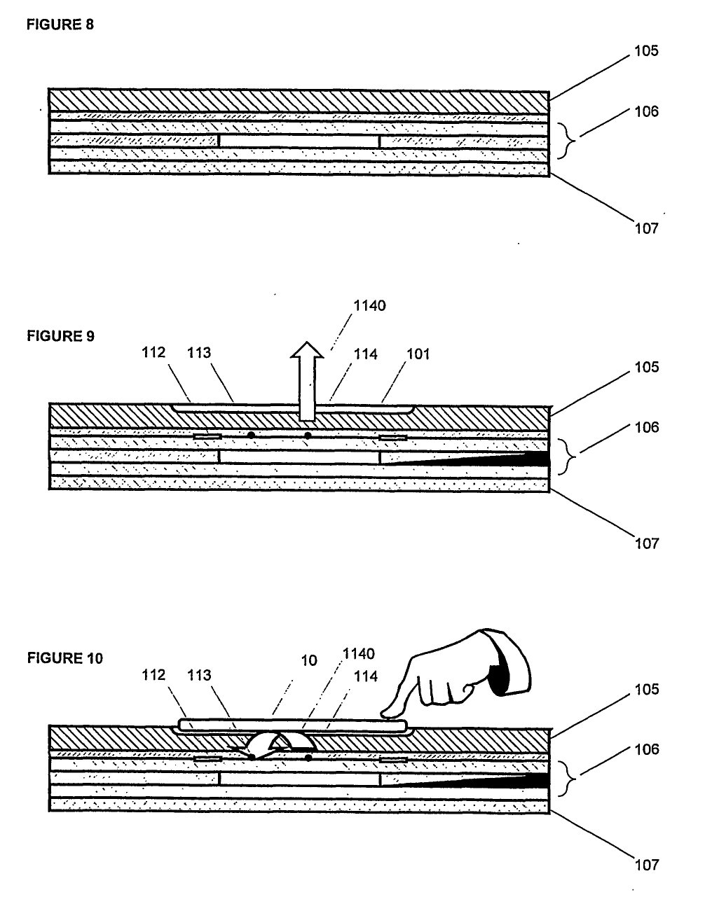

FIG. 8 shows the structure of a known non-tactile touch panel display 100 that comprises circuit layers 106 arranged between a graphic layer 105 and a glue layer 107. The graphic layer 105 is for example a clear non-reflective varnished window for a liquid crystal display (LCD) or a diffused window for light emitting diodes (LED's).

FIG. 9 shows the structure of an inventive non-tactile touch panel display 100 with a recess 101 for the placement of the IC-card 10 and with an antenna coil 112 arranged on one of the circuit layers 106. Below the recess 101, a light emitting diode 114 and an optical sensor 113 are provided on one of the circuit layers 106. As soon as an IC-card 10 is placed in the recess 101 the light 114 provided by the diode 114 is reflected, as shown in FIG. 10, to the optical sensor 113 thus allowing the controller to start the transaction sequence.

Programs used for performing the financial transaction may therefore be initialised by the placement of the IC-card 10 into the receptacle 101; 102. The placement of the IC-card 10 in the receptacle 101; 102 is thus detected by means of the optical sensor 113. The use of an optical sensor 113 thus prevents communication with other IC-cards that are in a closer range of the terminal 200. For that purpose, transmission power can also be adjusted to a level by which optimal communication conditions are provided for IC-cards 10 only that are placed in the receptacle 101; 102. For that purpose, also the coils of the antenna 112 can be designed accordingly, preferably by using smaller dimensions.

### REFERENCES

[1] U.S. Pat. No. 5,705,798
[2] U.S. Pat. No. 5,777,596
[3] International Publication WO 02/073522 A1
[4] EP 1 109 123 A1
[5] U.S. Pat. No. 6,142,381
[6] U.S. Pat. No. 6,211,936 B1
[7] International Publication WO 03/036561 A1
[8] EP 1 263 164 A1
[9] International Publication WO 00/10134
[10] International Publication WO 01/05085
[11] US 2003/0046590 A1

1. Terminal designed to perform transactions requested by the holder of an IC-card, comprising a touch panel display and means for contactless communication with the IC-card, characterised in that at least one antenna, designed to receive signals from and/or to send signals to the IC-card, is embedded in the touch panel display.

2. Terminal according to claim 1, characterised in that a communication module comprising a communication controller, a receiver and a transmitter connected to the antenna, is integrated in the touch panel display.

3. Terminal according to claim 1, characterised in that the communication module and the controller for the touch screen functionality of the touch panel display are implemented in a common circuit.

4. Terminal according to claim 1, characterised in that, adjacent to the antenna, the touch panel display comprises a receptacle designed to receive and hold the IC-card.

5. Terminal according to claim 4, characterised in that the receptacle is designed as a recess in the surface of the touch panel display or that receptacle is designed as a cavity with an opening slot in the surface of the touch panel display.

6. Terminal according to claim 4, characterised in that, adjacent to the receptacle at least one optical sensor is embedded in the touch panel display that detects receipt of an IC-card in the receptacle and/or that reads data written on the surface of the IC-card.

7. Terminal according to claim 1, designed as an access control terminal, a pay telephone or a point of sales terminal, such as ticket vending machine or an automatic teller machine.

8. Touch panel display in particular for a terminal as defined in claim 1, characterised in that at least one antenna, designed to receive signals from and/or to send signals to the IC-card, is embedded in the touch panel display.

9. Touch panel display according to claim 8, characterised in that a communication module comprising a communication controller, a receiver and a transmitter connected to the antenna, is integrated in the touch panel display.

10. Touch panel display according to claim 8, characterised in that the communication module and the controller for the touch screen functionality of the touch panel display are implemented in a common circuit.

11. Touch panel display according to claim 8, characterised in that, adjacent to the antenna, the touch panel display comprises a receptacle designed to receive and hold the IC-card.

12. Touch panel display according to claim 11, characterised in that the receptacle is designed as a recess in the surface of the touch panel display or that the receptacle is designed as a cavity with an opening slot in the surface of the touch panel display.

13. Touch panel display according to claim 11, characterised in that, adjacent to the receptacle, at least one optical sensor is embedded in the touch panel display that detects receipt of an IC-card in the receptacle and/or data written on the surface of the IC-card.

14. Touch panel display according to claim 8, characterised in that all data originating from the user side, data entered by the user and data read from the IC-card, are transmitted over a common data bus to the main processor and/or that the communication protocol used to exchange data with the IC-card is implemented within the touch panel display module.

15. Touch panel display according to claim 1, comprising a device designed to read biometric data, in particular data relating to a fingerprint.

16. Touch panel display according to claim 1, characterised in that the communication module, in particular the communication controller supports secure data entry and secure data transfer.
